(19) United States
(12) Patent Application Publication
(10) Pub. No.: US 2017/0152024 A1
(43) Pub. Date: Jun. 1, 2017

(54) DEVICE FORMING A TRAILING EDGE OF AN AERODYNAMIC PROFILE AND COMPRISING A BLOWING SYSTEM

(71) Applicant: Airbus Operations (S.A.S.), Toulouse (FR)

(72) Inventor: Jérôme Colmagro, Toulouse (FR)

(21) Appl. No.: 15/359,146

(22) Filed: Nov. 22, 2016

(30) Foreign Application Priority Data
Nov. 26, 2015 (FR) 1561433

(51) Int. Cl. B64C 21/04; B64D 27/26

(52) U.S. Cl. CPC B64C 21/04; B64D 27/26; F05D 2240/90

(57) ABSTRACT

A device including a profiled member conformed to constitute an edge portion of an aircraft aerodynamic profile. The device includes a blower chamber to be pressurized and an air ejector nozzle making it possible to provide fluidic communication between the blower chamber and an external surface of the profiled member, the profiled member, the blower chamber and the nozzle forming an assembly to be mounted in one piece on the aerodynamic profile to constitute a trailing edge thereof. The blower chamber and the nozzle are formed directly in the profiled member, the profiled member, the blower chamber and the air ejector nozzle being formed in one piece.

### CROSS-REFERENCE TO RELATED APPLICATION

This application claims priority to French Patent Application No. 1561433 filed Nov. 26, 2015, the entire disclosure of which is incorporated by reference herein.

### TECHNICAL FIELD

The disclosure herein relates to an aerodynamic profile provided with an air ejector device.

### BACKGROUND

According to one embodiment, the disclosure herein applies to a pylon supporting an aircraft propulsion assembly comprising an aerodynamic profile of this kind and an aircraft comprising a pylon of this kind.

During movement, any vehicle aerodynamic profile is exposed to the wake of other profiles of the vehicle or to phenomena disrupting its boundary layer of air. Aircraft in which the propulsion assembly is located on a pylon are of particular concern because the pylon generates a wake, regardless of how it is designed.

This is notably because the height of the boundary layer of the profile of the pylon increases in the downstream direction of the profile.

There therefore occurs at the trailing edge of a pylon a “speed defect” (or “speed deficit”) materialized by a difference between the speed of the free flow of the air and the local speed of the air in the downstream area of the profile.

The area subject to this speed defect is also the seat of a “mass flow defect” (or “mass flow deficit”) of air. Because of this, air tends to be drawn into the speed defect area, therefore producing turbulence.

In the case of a pylon supporting a propulsion assembly, notably with an unducted fan or airscrew, the speed discontinuity and the turbulence of the wake cause, among other things, an increase in the noise generated by the fans of the turbine of the propulsion assembly if the fans enter the wake of the pylon, which can be uncomfortable for passengers and in the environment. This is referred to as a “masking” effect.

There is therefore a requirement to limit this “masking” effect inducing a variation of pressure in the wake of the pylon.

In the specific case of pylons supporting propulsion assemblies, there is a requirement to eliminate the airflow deficit and therefore to reduce the speed deficit at their surface.

One of the solutions to achieve this consists in or comprises blowing air from a high-pressure source in the vicinity of the trailing edge of the profile in order to eliminate the airflow deficit and therefore to reduce the speed deficit.

With this aim, the document U.S. Pat. No. 4,917,336 describes an air ejector device including an air ejector nozzle in which air escapes via slots at the level of the extrados and the intrados of a pylon supporting an aircraft propulsion assembly. However, the above document describes complex and bulky embodiments the implementation of which remains imperfect.

### SUMMARY

According to the disclosure herein, a device including a profiled member is configured or conformed to constitute an extreme portion of an aircraft aerodynamic profile and to form a trailing edge of the profile. The device includes a blower chamber adapted or configured to be pressurized and an air ejector nozzle making it possible to provide fluidic communication between the blower chamber and an external surface of the profiled member. According to the disclosure herein, the profiled member, the blower chamber and the nozzle form an assembly adapted or configured to be mounted in one piece on the aerodynamic profile to constitute a trailing edge (BF).

The disclosure herein therefore provides a compact device integrating the essential functions of an aerodynamic profile blower system in order to reduce the disturbances in the wake thereof in the immediate vicinity of the trailing edge. Through a design allowing mounting in one piece, the device proposed by the disclosure herein is easy to implement, and in particular to mount on an element forming the anterior portion of the aerodynamic profile.

According to one embodiment, the profiled member, the blower chamber and the nozzle constitute a one-piece assembly. Consequently, the blower chamber and the nozzle are formed directly in the profiled member; the profiled member, the blower chamber and the air ejector nozzle being formed in one piece.

According to one embodiment, which the external surface includes at the level of an outlet of the nozzle a recess into which the ejector nozzle discharges.

The nozzle can advantageously take the form of a slot extending along the profiled member.

The device may include a plurality of nozzles. The device may include a first surface intended to form an extrados portion of the aerodynamic profile and a second surface intended to form an intrados portion of the aerodynamic profile, including a nozzle discharging at the level of the first surface and a nozzle discharging at the level of the second surface.

In a variant, the device may include a homogenization plate disposed in the blower chamber and defining a feed chamber and a blowing box.

In a variant, the blower chamber may include a distributor tube adapted or configured to feed it with air. In particular, the air distributor tube may be disposed in the feed chamber.

The disclosure herein also relates to an assembly forming an aircraft aerodynamic profile having a leading edge and a trailing edge defining a chord of the profile, the assembly including a device as described above.

The ejector nozzle can advantageously discharge at at least 70% of the chord of the profile and preferably at approximately 95% of the chord of the profile.

The assembly according to the disclosure herein may further include a scoop configured or conformed to scoop all or part of the boundary layer forming when air flows along the aerodynamic profile. The device may include a plurality of scoops. In particular, scoops may be distributed between the extrados and the intrados of the aerodynamic profile.

The scoop may be positioned between 50% and 90% of the chord of the profile and preferably at approximately 80% of the chord of the profile. A likewise anterior position of the scoop (or scoops) is made possible by the use in the assembly of a device according to the disclosure herein forming a trailing edge. When the assembly includes an ejector nozzle and a scoop, the scoop is advantageously farther away from the trailing edge than the nozzle.

The scoop may include a slot substantially parallel to the leading edge of the aerodynamic profile.

The disclosure herein relates finally to a pylon supporting an aircraft propulsion assembly including an assembly as described above. In a pylon of this kind, the blower chamber may be fed with air by the propulsion assembly.

Other particular features and advantages of the disclosure herein will become more apparent in the course of the following description.

### BRIEF DESCRIPTION OF THE DRAWINGS

In the appended drawings, provided by way of nonlimiting example:

FIG. 1 is a diagrammatic perspective view of an aircraft fuselage 1 including a propulsion system;

FIG. 2 is a diagrammatic perspective view of an aircraft propulsion assembly pylon in its immediate environment;

FIG. 3 represents diagrammatically in sectional side view a device conforming to one embodiment of the disclosure herein;

FIG. 4 represents diagrammatically a perspective view of a device conforming to the FIG. 3 embodiment;

FIG. 5 represents diagrammatically in a perspective view an assembly including the device from FIG. 4;

FIG. 6 represents diagrammatically a portion of an assembly conforming to one particular embodiment of the disclosure herein;

FIG. 7 shows diagrammatically an aerodynamic profile conforming to one particular variant of the disclosure herein;

FIG. 8 shows diagrammatically a pylon carrying an aircraft propulsion unit and including a device conforming to one embodiment of the disclosure herein.

### DETAILED DESCRIPTION

FIG. 1 shows an aircraft fuselage F equipped with two propulsion units which comprise an engine (in this instance a turbine) contained in a nacelle N and one or more pusher fans each including blades. A propulsion unit GP and its nacelle N form an aircraft propulsion assembly.

This nacelle N is supported and connected to the fuselage F by a pylon P. A pylon P constitutes a structural and functional connecting component between a propulsion unit GP of an aircraft and the structure of the aircraft (for example the fuselage F). In particular, a pylon includes an aerodynamic fairing enclosing a structure supporting the propulsion assembly and the devices that may be connected to it. The latter are not represented.

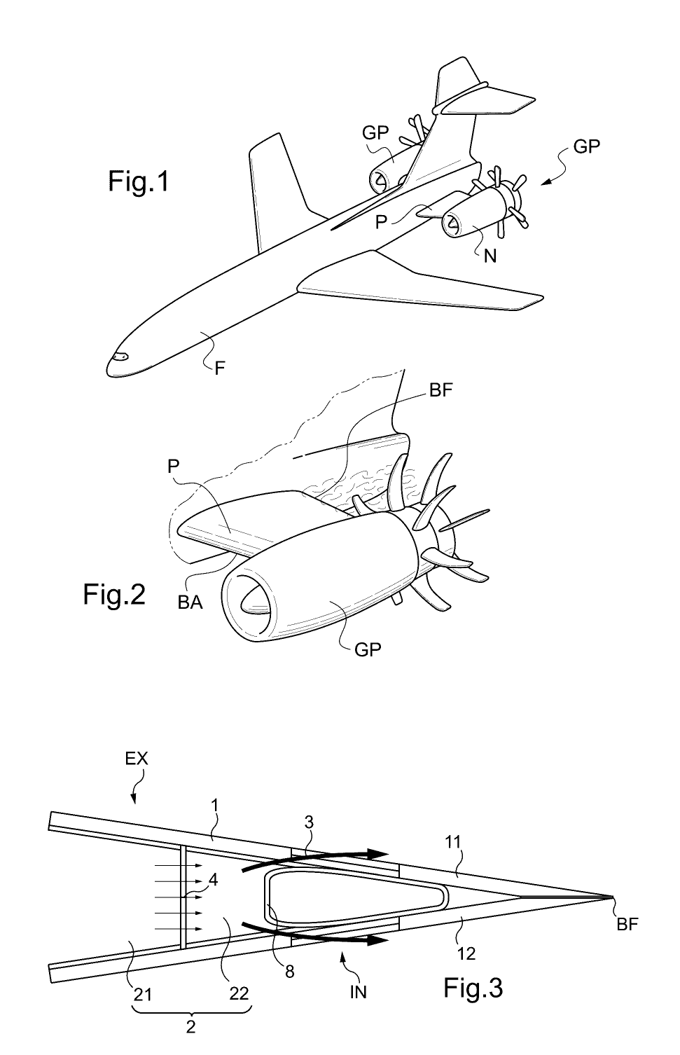

As explained above, in flight, the pylon P causes disturbance in its wake and turbulence shown in FIG. 2.

FIG. 2 represents in more detail a propulsion assembly pylon P of an aircraft in its immediate environment. In order to limit aerodynamic drag the pylon has an appropriate aerodynamic profile conferred on it by its fairing. An aerodynamic profile of this kind includes a leading edge BA and a trailing edge BF. The pylon is commonly made in a number of parts and the trailing edge may consist of or comprise a profiled member 1 mounted on the rest of the pylon. By profiled member is meant a component of fixed or varying section that constitutes an extreme portion of the aerodynamic profile. In the embodiment represented here, the profiled member has a substantially triangular section varying along the profiled member.

The passage into the wake of the pylon P of the blades of a fan, for example a propfan propulsion unit, can generate a high level of noise, the blades being subjected to aerodynamic disturbances and the “masking” effect that they generate.

Although aircraft propulsion assembly pylons constitute a preferred application of the disclosure herein, an analogous phenomenon can occur at the level of numerous other components of an aircraft, and the solution proposed by the disclosure herein may be generally applied to the latter.

In particular, FIG. 3 shows in section a device conforming to one embodiment of the disclosure herein. The device essentially includes a profiled member 1 intended to constitute an extreme portion of an aircraft aerodynamic profile. In particular, the profiled member 1 is configured or conformed to form the trailing edge BF of an aerodynamic profile, in this instance the trailing edge of a pylon fairing for an aircraft propulsion assembly.

The profiled member 1 is at least partly hollow. According to the disclosure herein, it includes a blower chamber 2 (also known as a “blowing box”) and an air ejector nozzle 3. The profiled member 1, the blower chamber 2 and the nozzle 3 form an assembly adapted or configured to be mounted in one piece on the aerodynamic profile to constitute a trailing edge (BF) thereof. The blower chamber 2 and the nozzle 3 may notably be formed directly in the profiled member 1 with the result that the profiled member 1, the blower chamber 2 and the air ejector nozzle are formed in one piece. In other words, in this case they constitute a monobloc structure. A monobloc structure of the main elements of a device according to the disclosure herein reduces the number of operations necessary to produce it and reduces its complexity.

In the embodiment represented here, the device further includes a homogenization plate 4 that divides the blower chamber into a feeder chamber 21 and a blowing box 22.

The homogenization plate makes it possible to homogenize the air by stirring it. The homogenization plate may for example comprise a plate including a multitude of perforations that the air passes through to reach the blowing box 22. In the embodiment example represented, the homogenization plate has a structural role in the construction of the device according to the disclosure herein. In particular, the device may include two plates joined to form the required angle of the profile at the level of the trailing edge, the plates being joined by the homogenization plate. According to a variant, the plates may form with the homogenization plate an isosceles triangle that optionally varies along the profiled member.

The device may include in the length of the profiled member a curved plate 8, typically of C-shape or a closed curve, forming a wall of the blowing box 22 and making it possible with at least one other wall of the blowing box to define slots forming a nozzle in line with the curvature of the curved plate 8. Alternatively, the device may have a solid extremity forming the trailing edge or one provided with openings and/or cavities. The curved plate 8, connected to the plates forming the angle of the trailing edge may equally make it possible to stiffen the structure mechanically, notably at the level of its edge. The structure obtained in this way is hollow, and therefore light in weight, whilst having a high stiffness. The curved plate 8 is preferably positioned in the immediate vicinity of the homogenization plate 4 in order to direct air leaving the homogenization plate toward the nozzle or nozzles 3.

The nozzle allows air to pass between the blower chamber 2, and more particularly the blowing box 22, and an external surface of the profiled member 1. In particular, the nozzle has an outlet oriented so that the air expelled by the nozzle is expelled in substantially the same direction as the flow of air flowing along the aerodynamic profile when the aircraft is in flight.

In the embodiment represented here, there are two nozzles on respective opposite sides of the device. In particular, one nozzle discharges onto a first surface 11 intended to form the extreme portion of the extrados EX of an aerodynamic profile and another nozzle discharges onto a second surface 12 intended to form the extreme portion of the intrados IN of the profile.

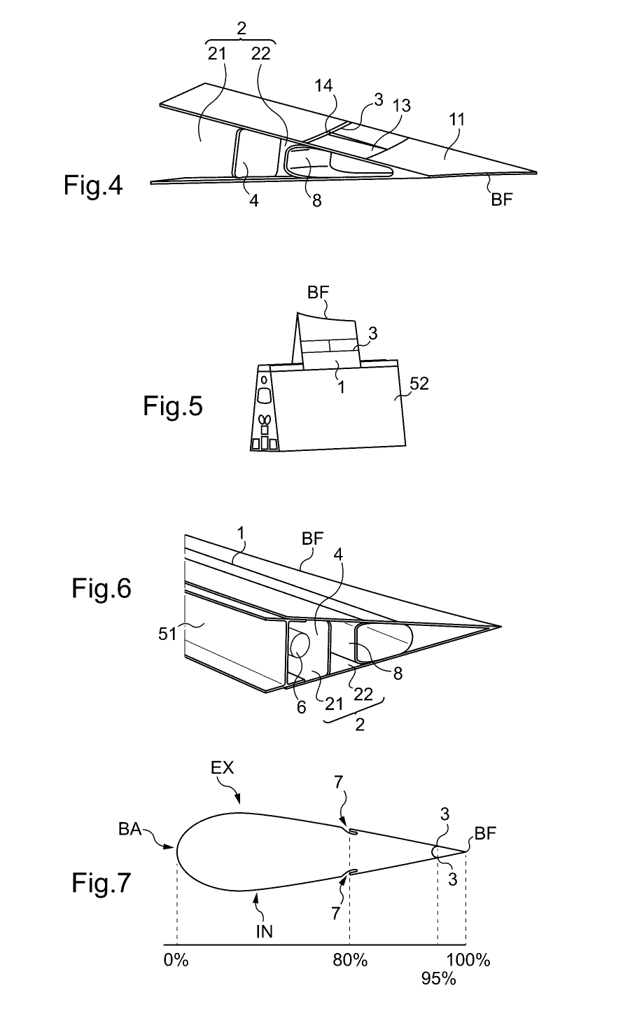

As shown clearly in FIG. 4, the external surface of the device includes at the level of an outlet of the nozzles 3 a recess 13 into which the nozzle 3 discharges. In the example represented here, the nozzle 3 takes the form of a slot extending along the profiled member 1. The slot forming the outlet of the nozzle may have a width of the order of 1 millimeter. In particular, the nozzle slot extends at the bottom of the recess 13. In the variant represented here, ribs 14 make it possible to stiffen the profiled member 1 and to prevent any mechanical weakening such as would be caused by the presence of the nozzles 3.

The profiled member may, for example, be machined in two steps. In a first step, a raw profiled member is produced by a molding process. In a second step, the nozzle/nozzles is/are machined, typically by mechanical machining (for example by drilling and/or milling) or by spark-erosion.

FIG. 5 represents diagrammatically an assembly including the device from FIG. 3 after assembly onto an anterior element of an aircraft propulsion unit pylon or another part defining an aerodynamic profile. In the example represented here the anterior element includes an intermediate part 52 and the device from FIG. 3 is assembled onto the intermediate part 52. The assembly may be effected using various fixing methods. As clearly visible in FIG. 5, the profiled member does not have a constant section. Moreover, in the example represented, the trailing edge BF formed by the profiled member 1 is not rectilinear. Fairings connected to the fuselage F of the aircraft on one side and to the nacelle N of the propulsion unit GP on the other side may be mounted on respective opposite sides of the profiled member 1, notably in the case of constructing a pylon supporting an aircraft propulsion assembly or unit. In the context of aircraft elements of larger span, a plurality of profiled members integrating one or more blower nozzles 3 may be used, end-to-end or separated by fairing portions forming the continuation of the trailing edge and free of any blower system.

FIG. 6 represents diagrammatically a part of an assembly conforming to one particular embodiment of the disclosure herein including a profiled member 1 assembled to a part such as an anterior element of an aircraft propulsion unit pylon at the level of an assembly part 51. In the example represented here, the assembly part 51 forms a wall of the blower chamber 2, which is therefore closed. In the embodiment represented in FIG. 6, the blower chamber is fed with air under pressure via an optional distributor tube 6. The distributor tube 6 is a tube running through the profiled member 1 in the blower chamber 2 and more particularly, where applicable, in the feed chamber 21. The distributor tube is pierced by a multitude of orifices providing distribution, for example homogenous distribution, of the air in the blower chamber. The distributor tube may be fed with air under pressure (that is to say at a pressure higher than atmospheric pressure or in any event higher than the pressure at the outlet of the nozzle 3) by an aircraft propulsion unit. It may in particular be the propulsion unit supported by the pylon equipped with the device according to the disclosure herein.

According to other variants of the disclosure herein, the blower chamber 2 or the feed chamber 21 of the blower chamber 2 may be fed directly with air under pressure, for example by an aircraft propulsion unit, without using a distribution tube.

In any embodiment of the disclosure herein other means or mechanisms of feeding air under pressure can be envisaged, such as an electric or mechanical compressor.

FIG. 7 show diagrammatically an aerodynamic profile conforming to one particular variant of the disclosure herein. As explained above, the turbulence in the wake of an aerodynamic profile is linked to the increasing thickness (height) of the boundary layer in the downstream direction of the profile. The problems linked to turbulence can be solved completely or partly by blowing as described above. Instead of or in addition to this blowing, it is also possible to reduce the thickness of the boundary layer by scooping all or part of this boundary layer. Reducing the thickness of the boundary layer acts directly on the source of the aerodynamic disturbances.

To this end, the aerodynamic profile may be equipped with one or more scoops 7. A scoop may typically be present on the extrados EX of the aerodynamic profile and a scoop may be present on the intrados IN of the aerodynamic profile.

The use of a device according to the disclosure herein makes it possible to position the blower nozzle or nozzles in the immediate vicinity of the trailing edge BF of the aerodynamic profile. The outlet or outlets of the nozzles can typically be disposed at more than 90% of the chord of the aerodynamic profile and preferably at approximately 95% of the chord of the profile. Remarkably, the blower chamber being integrated into the profiled member forming the trailing edge, the whole of the blowing system is compact and integrated into the rear extremity of the aerodynamic profile. This frees the volume in front of the blower system for the combined adoption of scoops which themselves may be situated far toward the rear of the profile, typically beyond 60% of its chord, and preferably around 80% of its chord. Disposed in this way, the scoops are highly effective because they are situated in an area in which the boundary layer is greatly thickened and sufficiently close to the leading edge to prevent significant re-thickening of the boundary layer downstream of the scoops.

The scoops may take the form of a slots, typically flush with the aerodynamic profile. They may have a width between 1 and 30 mm inclusive, for example. The scooped air may be fed into the blower chamber of the profiled member used in the disclosure herein. The air from the scoops, under pressure, can therefore feed at least in part a blower system employing a device according to the disclosure herein to constitute the trailing edge of an aircraft aerodynamic profile. Feeding the blower chamber with air under pressure may be complemented by air from an aircraft propulsion unit or a dedicated mechanical or electric compressor.

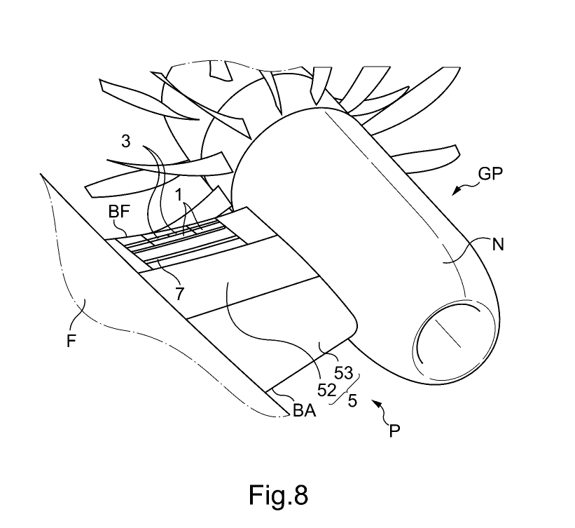

FIG. 8 shows diagrammatically a pylon P carrying an aircraft propulsion unit GP and including a device according to one embodiment of the disclosure herein. The pylon P structurally and functionally connects the fuselage F of an aircraft to the nacelle N of the propulsion unit GP. The pylon P forms an aerodynamic profile and includes a profiled member 1 forming its trailing edge and an anterior element 5 to which the trailing edge is connected. The anterior element 5 may include an intermediate part 52 and an anterior profiled member 53 forming its leading edge.

The device developed within the disclosure herein therefore offers numerous advantages compared to blower systems existing prior to the disclosure herein. In particular, it enables integration into a very small volume of all the means necessary for blowing, in the immediate vicinity of the trailing edge, that is to say where the blowing is the most effective in combating the aerodynamic disturbances generated in the wake of an aerodynamic profile. Moreover, the device proposed within the disclosure herein limits the integration constraints and avoids the complex assembly of the known devices, all the more so when it is of essentially monobloc construction. Finally, thanks to a disposition very much to the rear of the aerodynamic profile, the device may be combined with one or more scoops making it possible to scoop all or part of the boundary layer on the intrados and/or the extrados of the profile, and the scoops themselves may be disposed very much to the rear of the profile in an area in which they are highly effective.

While at least one exemplary embodiment of the disclosure invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A device including a profiled member configured to constitute an edge portion of an aircraft aerodynamic profile, the device comprising:
a blower chamber configured to be pressurized and an air ejector nozzle to provide fluidic communication between the blower chamber and an external surface of the profiled member;
the profiled member, the blower chamber and the nozzle forming an assembly configured to be mounted in one piece on the aerodynamic profile to constitute a trailing edge thereof; and
the blower chamber and the nozzle being formed directly in the profiled member, the profiled member, the blower chamber and the air ejector nozzle being formed in one piece.

2. The device according to claim 1, in which the external surface includes at a level of an outlet of the nozzle a recess into which the ejector nozzle discharges.

3. The device according to claim 1, in which the nozzle is in a form of a slot extending along the profiled member.

4. The device according to claim 1, comprising a first surface to form an extrados portion of the aerodynamic profile and a second surface to form an intrados portion of the aerodynamic profile, including a nozzle discharging at a level of the first surface and a nozzle discharging at a level of the second surface.

5. The device according to claim 1, in which the blower chamber and the nozzle discharging at a level of the first surface and the nozzle charging at a level of the second surface constitute a monobloc assembly.

6. The device according to claim 1, further including a homogenization plate disposed in the blower chamber and defining a feed chamber and a blowing box.

7. The device according to claim 1, in which the blower chamber includes a distributor tube configured to feed it with air.

8. The device according to claim 6, in which the air distributor tube is disposed in the feed chamber.

9. An assembly forming an aircraft aerodynamic profile having a leading edge and a trailing edge defining a chord of the profile, the assembly including a device according to claim 1.

10. The assembly according to claim 9, in which the ejector nozzle is configured to discharge at at least 70% of the chord of the profile and preferably at approximately 95% of the chord of the profile.

11. The assembly according to claim 9, further including a scoop configured to scoop all or part of a boundary layer forming when air flows along the aerodynamic profile.

12. The assembly according to claim 11, in which the scoop is positioned between 50% and 90% of the chord of the profile and preferably at approximately 80% of the chord of the profile.

13. The assembly according to claim 11, in which the scoop includes a slot substantially parallel to the leading edge of the aerodynamic profile.

14. A pylon supporting an aircraft propulsion assembly including an assembly according to claim 9.

15. The pylon according to claim 14, in which the blower chamber is fed with air by the propulsion assembly.
